(19) United States
(12) Patent Application Publication
(10) Pub. No.: US 2015/0180147 A1
(43) Pub. Date: Jun. 25, 2015

(54) COMBO CONNECTOR FOR MICRO SD AND MICRO USB/SSIC THIN CARDS

(71) Applicant: INDUSTRIAL TECHNOLOGY RESEARCH INSTITUTE, HSIN-CHU (TW)

(72) Inventors: YUAN-HENG SUN, New Taipei (TW); KANG-FENG LEE, Taipei (TW); CHIH-WEI HSU, Hsinchu (TW); CHIEN-HONG LIN, Hsinchu County (TW)

(73) Assignee: INDUSTRIAL TECHNOLOGY RESEARCH INSTITUTE, HSIN-CHU (TW)

(21) Appl. No.: 14/189,439

(22) Filed: Feb. 25, 2014

(30) Foreign Application Priority Data
Dec. 24, 2013 (TW) 102148009

(51) Int. Cl. H01R 12/71; H01R 13/46

(52) U.S. Cl. CPC H01R 12/71; H01R 13/46

(57) ABSTRACT

A combo connector for Micro SD and Micro USB/SSIC thin cards includes a casing having an accommodation space to contain a thin card; a conductive terminal unit including a first conductive terminal set and a second conductive terminal set which are arranged separately at two different locations in the casing; a position member located and sliding in the casing between a first position and a second position; and a conduction unit located in the casing further including a first conductive element and a second conductive element to activate the conduction unit to recognize the thin card while an electric connection between the first conductive element and the second conductive element are established. The thin card contacts correspondingly the two conductive terminal sets while the position member is reached at the second position.

### CROSS REFERENCE TO RELATED APPLICATION

This application also claims priority to Taiwan Patent Application No. 102148009 filed in the Taiwan Patent Office on Dec. 24, 2013, the entire content of which is incorporated herein by reference.

### TECHNICAL FIELD

The present disclosure relates to a combo connector for micro SD and micro USB/SSIC thin cards.

### BACKGROUND

With persistent prosperity in the industry of digital information, recent products show a trend of short-and-thin, high performance and low power consumption. Hence, there emerges an urgent need for small, rapid and energy-saving memory cards, such as the SD cards, MMC cards, MS cards, CF cards, XD cards and so on. By having the Micro SD cards as an example, the market demand for year 2010 is about a billion pieces.

Except for those electronic cards with different specs, various types of cards are also developed to the need of the mobile electronic devices such as the low-power embedded memory card, the micro USB/SSIC thin card (MUTC), supper speed inter-chip card (SSIC), and so on. In particular, the MUTC uses the USB 3.0 protocol and software to perform the upper architecture communication and application, and on the other hand uses the low power fused-architecture M-PHY technology to perform the universal serial bus device for the bottom architecture transportation apparatus, such that the power consumption can be reduced and the applicability requirement for the portable electronic devices such as mobile phones, tablet computers and so on can be met.

However, for some limitations (for example, the power consumption specs of the USB can't meet the low power consumption requirement of the mobile apparatus), upgrading upon the interface band widths (for example, increasing of the resolution for the LED of the electronic apparatus from 128×64 to 2048×1536, upgrading of the imaging quality from a CIF quality to a 3264×2448−8 MP quality, or upgrading of the memory card from 128 MB to 64 GB) can't be effectively achieved. Further, if the functions of the electronic apparatus are greatly expanded, additional interfacing would definitely make complicated the design of the software and the hardware. For example, the application of a 8˜24-bit parallel interface for the LED screen is bigger in volume, and also its asymmetrical single ended current mode would induce a serious EMI to damage the communication quality.

Hence, if the MUTC card and the Micro SD card are to be integrated into a unique electronic apparatus, more research is definitely needed. However, current electronic card connectors in the marketplace are yet to answer this question.

### SUMMARY

In one exemplary embodiment of this disclosure, the combo connector for micro SD and micro USB/SSIC thin cards, which is applicable to a first electronic card and a second electronic card, comprises a casing, a conductive terminal unit, a position member and a conduction unit.

The casing further has an accommodation space to receive one of the first electronic card and the second electronic card.

The conductive terminal unit further includes a first conductive terminal set and a second conductive terminal set. The first conductive terminal set and the second conductive terminal set are arranged at different locations of the casing.

The position member, located inside the casing, is to move between a first position and a second position. In the case that the position member is at the second position, the first electronic card or the second electronic card received inside the accommodation space contacts with the corresponding first conductive terminal set or the second conductive terminal set.

The conduction unit, located inside the casing, further includes a first conductive element and a second conductive element for having the conduction unit to form an electric contact connection to recognize one of the first electronic card and the second electronic card received inside the accommodation space.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of an embodiment of the combo connector in this disclosure;

FIG. 2 is a top view of FIG. 1;

FIG. 3A is a schematic exploded view of an embodiment of the elastic unit in this disclosure;

FIG. 3B is a front view of FIG. 3A;

FIG. 4A shows a state of the elastic unit of FIG. 3A;

FIG. 4B shows another state of the elastic unit of FIG. 3A;

FIG. 5A shows the combo connector of FIG. 2 and a first electronic card in a separate state;

FIG. 5B shows the combo connector of FIG. 2 and the first electronic card in an engagement state;

FIG. 6A shows the combo connector of FIG. 2 and a second electronic card in a separate state;

FIG. 6B shows the combo connector of FIG. 2 and the second electronic card in an engagement state; and

FIG. 7 is a cross-sectional view of an embodiment of the stop structure in this disclosure.

### DETAILED DESCRIPTION

The present disclosure relates to a combo connector for micro SD and micro USB/SSIC thin cards. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

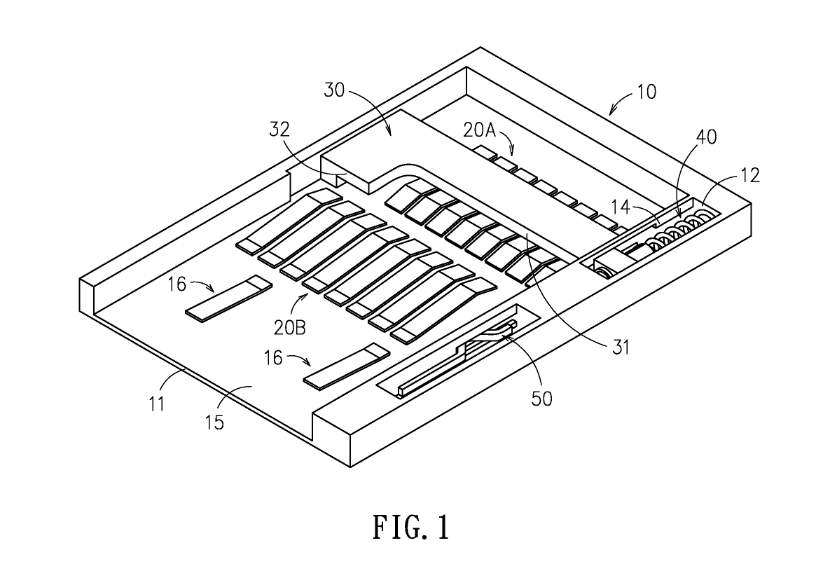

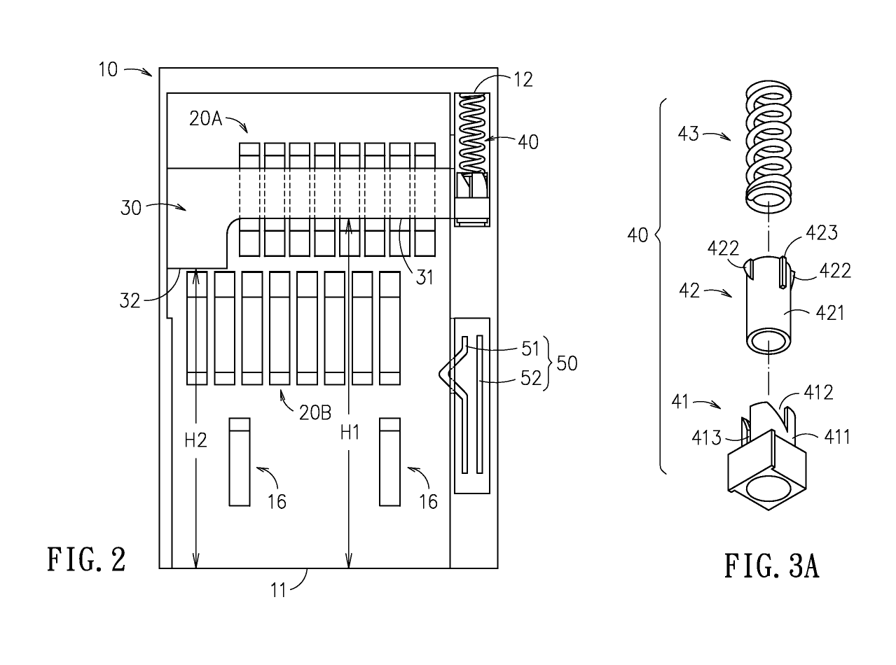

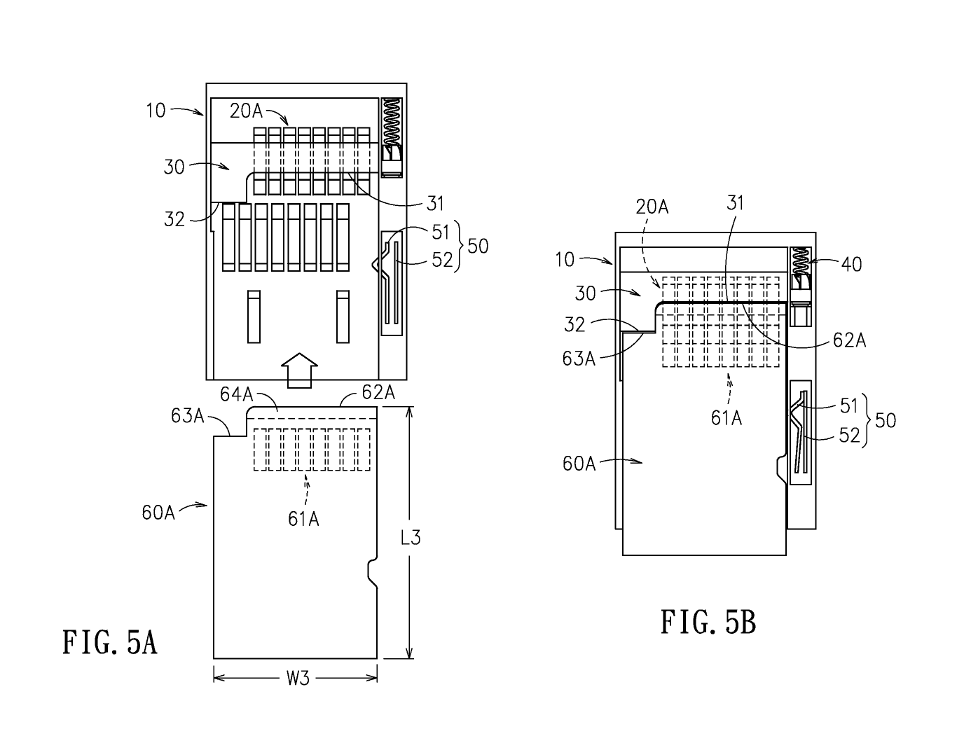

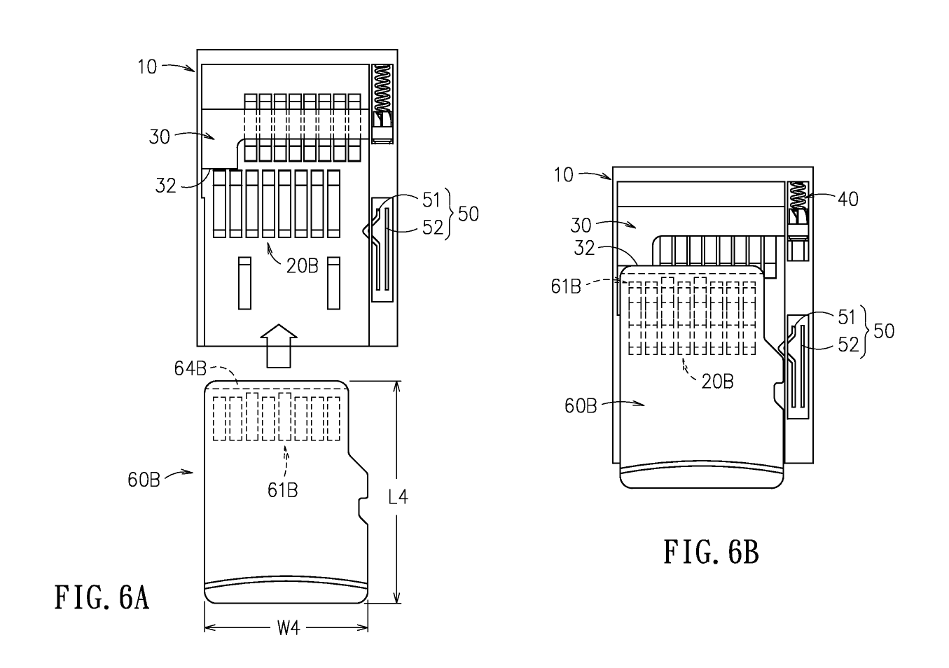

Referring now to FIG. 1 and FIG. 2, an embodiment of the combo connector for micro SD and micro USB/SSIC thin cards in this disclosure is shown in a perspective view and a top view, respectively. The combo connector includes a casing 10 providing an accommodation space for receiving various types of the electronic cards. For example shown in FIG. 5A, a first electronic card 60A to be received by the casing 10, which can be an MUTC (Micro USB/SSIC Thin Card), an SSIC (Super Speed Inter-Chip), and any the like. Also, for example shown in FIG. 6A, a second electronic card 60B to be received by the casing 10, which can be a Micro SD card. The first electronic card 60A has a plurality of first conductive plates 61A, while the second electronic card 60B has a plurality of second conductive plates 61B. The casing 10 is generally made of an insulation material. The casing 10 further has a receiving end 11 formed to have a slot opening for allowing any one of the aforesaid various electronic cards to enter the accommodation space of the casing 10 through the receiving end 11. The casing 10 can further have an upper cover (not shown in the figure) to perform as a seal to the accommodation space.

In the casing 10, a conductive terminal unit includes a first conductive terminal set 20A and a second conductive terminal set 20B. The first conductive terminal set 20A and the second conductive terminal set 20A are separately mounted to different locations inside the casing 10. As shown, the first conductive terminal set 20A is located away from the receiving end 11, by compared to the location of the second conductive terminal set 20B.

The casing 10 further includes thereinside a position member 30. The position member 30 sliding along a track (not shown in figure) inside the casing 10 further has a first lateral side 31 and a second lateral side 32, both of which are facing the receiving end 11 and formed integrally as a step structure. As shown in FIG. 2, the first lateral side 31 is spaced from the receiving end 11 by a first distance H1, the second lateral side 32 is spaced from the receiving end 11 by a different second distance H2, and the first distance H1 is larger than the second distance H2.

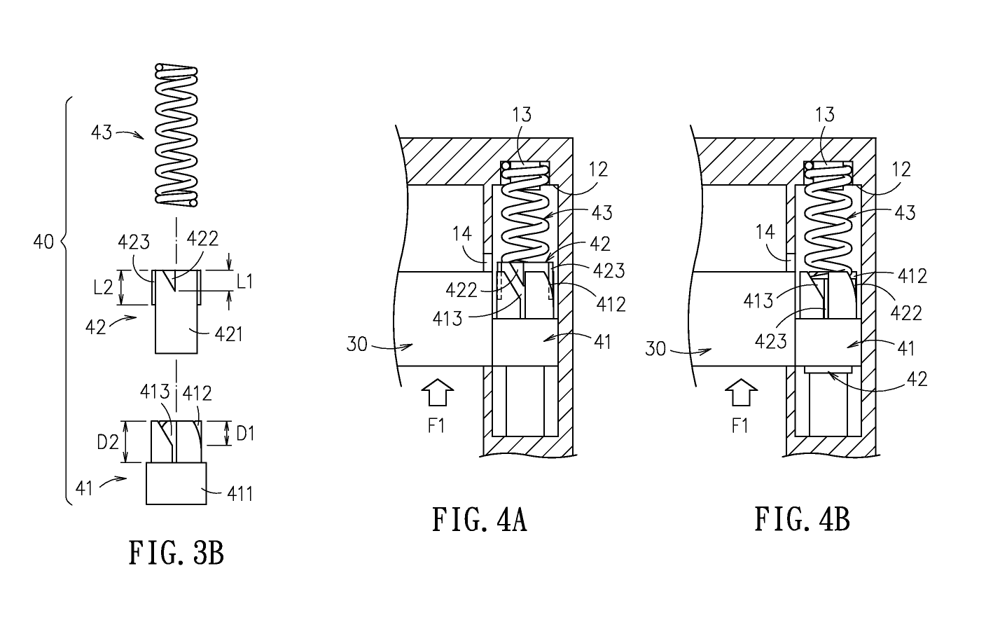

Refer now to FIG. 1 through FIG. 3B. the casing 10 includes an elastic unit 40 further having a first element 41, a second element 42 and a spring element 43.

The first element 41 engaged with the position member 30 has a socket 411, two triangle-shaped first slots 412 and two slender triangle-shaped second slots 413. As shown, the first slots 412 and the second slots 413 are all constructed at one end of the socket 411 and extended along an axial direction of the socket 411, in which each of the first slots 412 is neighbored by the two second slots 413 and also each of the second slots 413 is neighbored by the two first slots 412. The first slot 412 has a first depth D1 along the axial direction of the socket 411, the second slot 423 has a second depth D2 along the axial direction, and the second depth D2 is larger than the first depth D1.

The second element 42 includes a shaft 421, two triangle-shaped first protrusions 422 and two slender triangle-shaped second protrusions 423. The two triangle-shaped first protrusions 422 and two slender triangle-shaped second protrusions 423 are constructed exteriorly at one end of the shaft 421 by having each of the first protrusions 422 to be located between the two second protrusions 423 and also having each of the second protrusions 423 to be located between the two first protrusions 422. In particular, the shape of the second protrusion 423 can be formed to pair that of the second slot 413. The first protrusion 422 has a first length L1 along the axial direction of the shaft 421, the second protrusion 423 has a length L2 along the axial direction, and the second length L2 is larger than the first length L1. The shaft 421 is to be sleeved into the socket 411. Alternatives, other pairs of the aforesaid protrusion and the corresponding slot can also be adopted, if and only if the engaging in between can be smooth and generate sideward forcing for rotating the second element 42.

The spring element 43 located between an interior wall 12 of the casing 10 and the second element 42 is to provide a spring force to the second element 42. For the second element 42 is sleeved inside along the first element 41 and the first element 41 is connected with the position member 30, the spring force can indirectly apply to the first element 41 and the position member 30. As shown in FIG. 1 and FIG. 2, the position member 30 is at a relief state where the spring element 43 extends to have the position member 30 anchored at a first position.

Refer now to FIG. 4A and FIG. 4B. In this embodiment, a protrusive pillar 13 is protruded from the interior wall 12 of the casing 10 so as to allow the spring element 43 to be anchored therearound. By providing the elastic unit 40 to connect with the position member 30, in the case that a first direction forcing F1 is applied to the position member 30, the second element 42 is rotated by the depression of the first element 41. Upon every forcing, the engagement state between the first element 41 and the second element 42 is varied for the contact points of the first protrusion 422 and the second protrusion 423 at the first slot 412 and the second slot 413 are shifted due to the rotation motion of the second element 42. Further, by providing the resilience of the spring element 43, the position member 30 can undergo elastically both the backward and forward motions.

In order not to over-depress the position member 30, the casing 10 includes a constraint structure 14 to define the stroke of the position member 30, as shown in FIG. 1. Alternatively, but not limited thereto, the casing 10 can also include a stop wall (not shown in the figure) to replace the aforesaid constraint structure.

Refer now to FIG. 1 and FIG. 2. The casing 10 has a conduction unit 50 further including a first conductive element 51 and a second conductive element 52, both of which are made of a conductive material. The first conductive element 51 is fixed to the casing 10 and connected with a circuit (not shown in the figure), but also have a middle portion thereof to protrude into the accommodation space of the casing 10. The second conductive element 52 is located at the casing 10 and connects with another circuit (not shown in the figure). As shown, the first conductive element 51 is separate from the second conductive element 52. In the case that the first conductive element 51 is forced, at the protrusive middle portion to, inward to close and touch the second conductive element 52, an electric contact connection between the first conductive element 51 and the second conductive element 52 is formed. Such an electric contact connection is to recognize which type of the electronic card is received by the accommodation space of the combo connector.

Refer now to FIG. 5A and FIG. 5B. A first electronic card 60A is to be sent to be received by the combo connector of FIG. 1, as shown in FIG. 5A. The first electronic card 60A can be an MUTC (Micro USB/SSIC Thin Card) having a third width W3 and a third length L3. The leading edge of the first electronic card 60A that faces the position member 30 in FIG. 5A further has a third lateral side 62A and a fourth lateral side 63A, in which the third lateral side 62A and the fourth lateral side 63A are integrated to form a step structure. Typically, the third width W3 is about 11 mm, and the third length L3 is about 17 mm. In the step structure, about a 2 mm offset exists between the third lateral side 62A and the fourth lateral side 63A. As the first electronic card 60A is at a position separate to the casing 10 as shown in FIG. 5A, the position member 30 is at a relief state, at which the first conductive element 51 and the second conductive element 52 are separate. As the first electronic card 60A is sent into the casing 10, the third lateral side 62A can contact with the first lateral side 31 of the position member 30, and then the fourth lateral side 63A can just contact with the second lateral side 32 of the position member 30 so as to push the position member 30. As the position member 30 is pushed backward to hit at the constraint structure 14 of FIG. 1, the backward motion is stopped. At this instant, the position member 30 is at a second position, the first conductive plate 61A of the first electronic card 60A contacts the first conductive terminal set 20A so as to establish an electric connection in between. Also, at this moment, a lateral side of the first electronic card 60A contacts the conduction unit 50 and pushed the first conductive element 51 backward gradually to approach the second conductive element 52. Finally, as the first electronic card 60A moves further into the casing 10, the first conductive element 51 would contact with the second conductive element 52, and then the electric contact connection in the conduction unit 50 is formed, as shown in FIG. 5B. Upon such an arrangement, the circuit connecting the second conductive element 52 can be activated so as to perform the recognizing whether the incoming card is a first electronic card or a second electronic card and also to process the data management. On the other hand, to retrieve the first electronic card 60A, the first electronic card 60A in the casing 10 is slightly pushed inward further so as to have the first electronic card 60A to push the position member 30 and thus to trigger the elastic unit 40. As the elastic unit 40 is triggered, the resilience of the spring element 43 would be relieved to bounce back the first electronic card 60A. Then, the first electronic card 60A can be fetched out of the casing 10. It is noted that the design of the constraint structure 14 in FIG. 1 should provide enough room for the electronic card to retrieve.

Refer now to FIG. 6A and FIG. 6B. A second electronic card 60B is to be sent to be received by the combo connector of FIG. 1, as shown in FIG. 6A. The second electronic card 60B can be a Micro SD card having a fourth width W4 and a fourth length L4. As the second electronic card 60B at a position separate from the casing 10, the position member 30 is at the relief state as shown in FIG. 6A. As the second electronic card 60B is sent into the casing 10, the second electronic card 60B can only contact with the second lateral side 32 and can push the position member 30. When the position member 30 is pushed to hit the constraint structure 14 shown in FIG. 1, the inward motion of the second electronic card 60B is stopped. At this time, the position member 30 is at the second position where the second conductive plate 61B of the second electronic card 60B can contact with the second conductive terminal set 20B so as to establish an electric connection in between. It is noted that, when the second electronic card 60B is inserted, the conduction unit 50 is not pushed anyway. Namely, the first conductive element 51 is separate from the second conductive element 52, and thus the circuit connecting the second conductive element 52 is not activated, as shown in FIG. 6B. Similarly, to retrieve the second electronic card 60B, the second electronic card 60B in the casing 10 is slightly pushed inward further so as to have the spring element 43 of the elastic unit 40 to bounce the second electronic card 60B out of the casing 10.

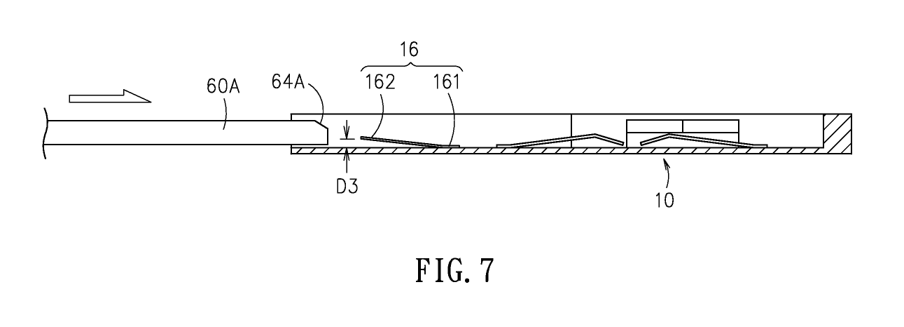

Refer now to FIG. 1 and FIG. 7. The mounting surface 15 that loads the electronic card in the casing 10 includes two stop structures 16, and each of the stop structures 16 further has a first end 161 and a second end 162, in which the first end 161 is mounted on the mounting surface 15 and the second end 162 is a free end to protrude into the accommodation space of the casing 10. As shown in FIG. 7, a spacing D3 exists between the second end 162 and the mounting surface 15. By having the first electronic card 60A of FIG. 5A or the second electronic card 60B of FIG. 6A as an example, the front edge of the third lateral side 62A is formed to have a chamfer structure 64A or 64B. To prevent possible damage of the casing 10 from ill inserting of the first electronic card 60A or the second electronic card 60B, the stop structure of FIG. 7 is then introduced. By having the first electronic card 60A as an example, when the first electronic card 60A is inserted in an upside-down manner, then the chamfer structure 64A would face upward, such that the lower edge of the first electronic card 60A would interface with the stop structure 16 and thus fail to nest in position inside the casing 10. However, if the inserting is performed correctly according to FIG. 5A or FIG. 6A, then the chamfer structure 64A or 64B of the first electronic card 60A or the second electronic card 60B would depress the stop structure 16 smoothly so as to have the first electronic card 60A or the second electronic card 60B to enter the casing 10 easily and correctly. Nevertheless, the stop structure 16 is simply one of various exemplary embodiments to serve the same purpose of having the electronic card to enter the accommodation space safely and correctly. Alternatively, a single stop structure, a node or any other protrusion can also be appropriately applied to replace the aforesaid design of the stop structure 16.

In the disclosure, the combo connector for electronic cards can accept various types of the electronic cards, including the MUTC and the Micro SD card. Thereby, the application of the connector can be made broader. Further, the introduction of the position member can see the type of the incoming electronic card to assign its electric connection to either the conductive terminal set or the conduction unit. Upon such an arrangement, ill inserting of the electronic card into the casing can be avoided. Furthermore, the elastic unit is included so as to facilitate the engaging and the disengaging of the electronic card, and the stop structure is just enough to ensure a correct inserting of the electronic card.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A combo connector for micro SD and micro USB/SSIC thin cards, applicable to a first electronic card and a second electronic card, comprising:
a casing having an accommodation space, configures to receive one of the first electronic card and the second electronic card;
a conductive terminal unit, including a first conductive terminal set and a second conductive terminal set, the first conductive terminal set and the second conductive terminal set are arranged to be inside the casing at different locations;
a position member, located inside the casing, configurs to move between a first position and a second position, wherein, while the position member is at one of the first position and the second position, one of the first electronic card and the second electronic card received inside the accommodation space contacts with corresponding one of the first conductive terminal set and the second conductive terminal set; and
a conduction unit located inside the casing, including a first conductive element and a second conductive element configures to have the conduction unit to form an electric contact connection to recognize one of the first electronic card and the second electronic card received inside the accommodation space.

2. The combo connector according to claim 1, wherein the position member has a first lateral side and a second lateral side, the casing has a receiving end, the first lateral side is spaced from the receiving end by a first distance H1, the second lateral side is spaced from the receiving end by a second distance H2, and the first distance H1 is larger than the second distance H2.

3. The combo connector according to claim 1, wherein one end of the first electronic card includes a third lateral side and a fourth lateral side, and the third lateral side and the fourth lateral side are integrally formed as a step structure.

4. The combo connector according to claim 1, further including an elastic unit, the elastic unit further comprising:
a first element, connected with the position member, further having a socket, a plurality of first slots and a plurality of second slots, wherein the plurality of the first slots and the plurality of the second slots are separately structured at opposing ends of the socket.
a second element, further having a shaft, a plurality of first protrusions and a plurality of second protrusions, wherein the plurality of the first protrusions and the plurality of the second protrusions are separately mounted at an exterior of the shaft, and the shaft is to protrude into the socket; and
a spring element, mounted between an interior wall of the casing and the second element.

5. The combo connector according to claim 4, wherein each of the first slots extends along an axial direction of the socket by a first depth D1, each of the second slots extends along the axial direction by a second depth D2, the second depth D2 is larger than the first depth D1, each of the first protrusions extends along the axial direction by a first length L1, each of the second protrusions extends along the axial direction by a second length L2, and the second length L2 is larger than the first length L1.

6. The combo connector according to claim 4, wherein the first slots and the first protrusions are triangle-shaped, and the second slots and the second protrusions are shaped as slender triangles.

7. The combo connector according to claim 1, wherein the first conductive element protruded into the accommodation space forms an electrical contact connection with the second conductive element while the first conductive element is pushed back to contact the second conductive element by one of the first electronic card and the second electronic card.

8. The combo connector according to claim 1, wherein the casing further has a stop structure protruding into the accommodation space for resisting the electronic card to enter the accommodation space.

9. The combo connector according to claim 8, wherein the stop structure has a first end and a second end, the first end is mounted on a mounting surface of the casing, the second end protrudes into the accommodation space, and a spacing D3 exists between the second end and the mounting surface.

10. The combo connector according to claim 1, wherein the first electronic card is an MUTC (Micro USB/SSIC Thin Card) and the second electronic card is a Micro SD card.

11. The combo connector according to claim 3, wherein the third lateral side of the first electronic card further has a chamfer structure.
